(19) United States
(12) Patent Application Publication
(10) Pub. No.: US 2020/0397663 A1
(43) Pub. Date: Dec. 24, 2020

(54) STORAGE RACK STRUCTURE AND STORAGE PANEL MODULE THEREOF

(71) Applicants: Kuo-Liang LU, Taipei City (TW); Fu-Chi TSAI, Taipei City (TW)

(72) Inventors: Kuo-Liang LU, Taipei City (TW); Fu-Chi TSAI, Taipei City (TW)

(21) Appl. No.: 16/905,951

(22) Filed: Jun. 19, 2020

(30) Foreign Application Priority Data
Jun. 24, 2019 (TW) 108121938

(51) Int. Cl. A61J 7/00; G07F 11/28

(52) U.S. Cl. CPC A61J 7/0084; G07F 11/28

(57) ABSTRACT

A storage rack structure and a storage panel module thereof are disclosed. The storage panel module includes an inclined carrying panel, a rolling unit and a plurality of storage boxes. The inclined carrying panel has an inclined top wall and a first lateral side and a second lateral side arranged at two sides of the inclined top wall, and a height of the inclined top wall is gradually reduced from the first lateral side to the second lateral side. The rolling unit is disposed on the inclined top wall and crossly arranged between the first lateral side and the second lateral side. The storage boxes are disposed on the inclined top wall and the rolling unit and adjacently arranged between the first lateral side and the second lateral side. Accordingly advantages of easily taking out medicines and efficiently managing expire dates of the medicines are provided.

### BACKGROUND OF THE INVENTION

### Field of the Invention

The present invention relates to a carrying structure for storing goods, especially to a storage rack structure and a storage panel module thereof.

### Description of Related Art

When medicines are improperly arranged, overly stacked or poorly disposed, or the dispensed medicines are not timely returned and accurately arranged after being taken out, the medicines may be arranged in wrong positions, and a problem of wrongly dispensing medicines may happen. As such, how to design a medicine storage rack for allowing the medicines to be easily taken out and expire dates of the medicines to be managed is concerned by the applicant of the present invention for providing a novel medicine storage rack.

Accordingly, the applicant of the present invention has devoted himself for improving the mentioned disadvantages.

### SUMMARY OF THE INVENTION

The present invention is to provide a storage rack structure and a storage panel module thereof, in which when a storage box adjacent to a second lateral side is taken out, other storage boxes on an inclined top wall are able to automatically slide from the first lateral side towards a second lateral side through a rolling unit, so that the storage rack structure and the storage panel module thereof are provided with advantages of easily taking out medicines and efficiently managing expire dates of the medicines.

Accordingly, the present invention provides a storage rack structure, which includes: a rack body, having at least one layer plate; and a plurality of storage panel modules, disposed on the layer plate, wherein each of the storage panel modules has an inclined carrying panel and a first lateral side and a second lateral side arranged at two sides of the inclined top wall, and a height of the inclined top wall is gradually reduced from the first lateral side to the second lateral side; at least one rolling unit, disposed on the inclined top wall and crossly arranged between the first lateral side and the second lateral side; and a plurality of storage boxes, disposed on the inclined top wall and the rolling unit and adjacently arranged between the first lateral side and the second lateral side.

Accordingly, the present invention provides a storage panel module, which includes: an inclined carrying panel, having an inclined top wall and a first lateral side and a second lateral side arranged at two sides of the inclined top wall, wherein a height of the inclined top wall is gradually reduced from the first lateral side to the second lateral side; at least one rolling unit, disposed on the inclined top wall and crossly arranged between the first lateral side and the second lateral side; and a plurality of storage boxes, disposed on the inclined top wall and the rolling unit and adjacently arranged between the first lateral side and the second lateral side.

Based on what has been disclosed above, when an expire date managing operation for the medicines is desired to be processed, the expire date which is about to reach is disposed more closer to the second lateral side, and the medicines stored in the storage box adjacent to the second lateral side are firstly taken out, so that, with the storage boxes and the rolling units, the expire dates, from the newest to the oldest, of the medicines can be automatically managed and arranged from the first lateral side to the second lateral side of the inclined top wall.

Based on what has been disclosed above, when the rolling unit is damaged due to being worn by friction while rolling in a long period of time or adhered with dirt and unable to roll, the old rolling unit can be directly removed from a recess, and the new rolling unit is disposed in the recess for a purpose of replacement, and a conventional means of replacing the whole inclined carrying panel is not required, thereby allowing the storage panel module to be provided with effects of easily replacing the rolling unit and saving a maintenance cost.

### BRIEF DESCRIPTION OF DRAWINGS

FIG. 1 is a schematic view showing an operating status of a storage rack structure according to the present invention;

FIG. 2 is a perspective view showing the assembly of the storage panel module according to the present invention;

FIG. 3 is a perspective exploded view showing the storage panel module according to the present invention;

FIG. 4 is another perspective exploded view showing the storage panel module according to the present invention;

FIG. 5 is a schematic view showing a first operating status of the storage panel module according to the present invention;

FIG. 6 is a schematic view showing a second operating status of the storage panel module according to the present invention;

FIG. 7 is a schematic view showing a third operating status of the storage panel module according to the present invention;

FIG. 8 is a perspective view showing the inclined carrying panel according to another embodiment the present invention; and

FIG. 9 is a cross sectional view showing the inclined carrying panel according to the another embodiment the present invention.

### DETAILED DESCRIPTION OF THE INVENTION

Preferred embodiments of the present invention will be described with reference to the drawings.

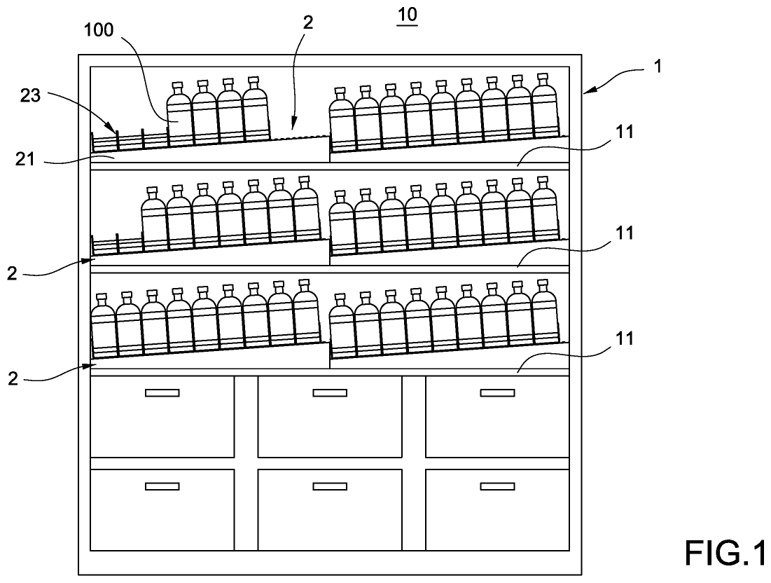

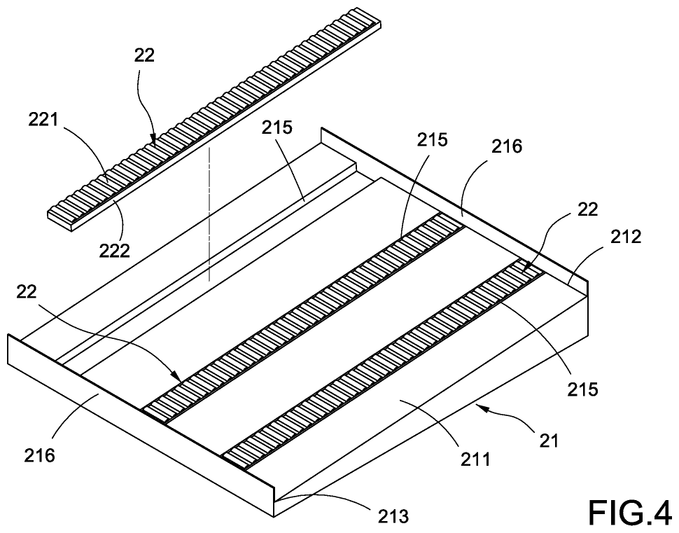

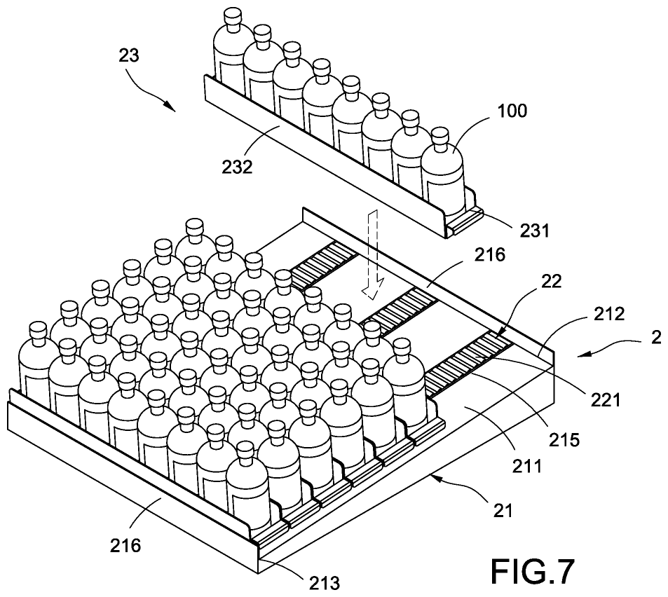

Please refer from FIG. 1 to FIG. 7, the present invention provides a storage rack structure and a storage panel module thereof. The storage rack structure 10 mainly includes a rack body 1 and a plurality of storage panel modules 2. The storage panel module 2 mainly includes an inclined carrying panel 21, one or a plurality of rolling units 22 and a plurality of storage boxes 23.

As shown in FIG. 1, the rack body 1 has one or a plurality of layer plates 11; according to this embodiment, there are three layer plates 11, but what shall be addressed is that the scope of the present invention is not limited to the above-mentioned arrangement; and the storage panel modules 2 are disposed on each of the layer plates 11.

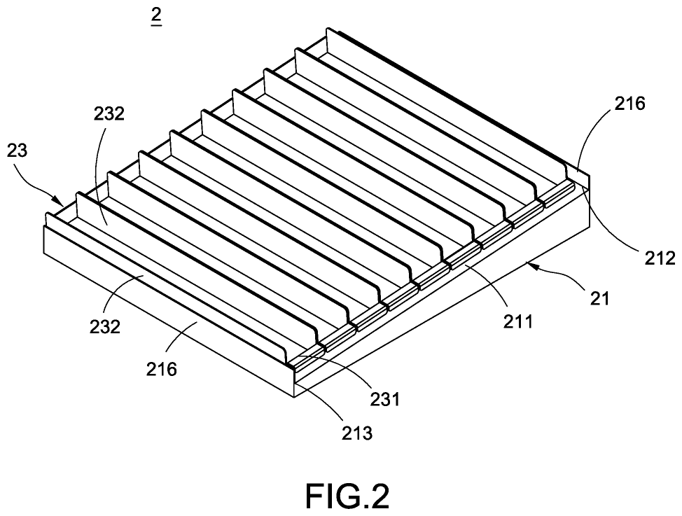

As shown from FIG. 2 to FIG. 7, each of the storage panel modules 2 has the inclined carrying panel 21, the one or the plurality of rolling units 22, and the plurality of storage boxes 23.

Details are provided as follows. The inclined carrying panel 21 has an inclined top wall 211, and a first lateral side 212 and a second lateral side 213 defined at two sides of the inclined top wall 211, and a height h of the inclined top wall 211 is gradually reduced from the first lateral side 212 to the second lateral side 213.

Moreover, the inclined top wall 211 has a plurality of recesses 215 crossly arranged between the first lateral side 212 and the second lateral side 213, and the inclined carrying panel 21 has two stopping plates 216 upwardly extended from the first lateral side 212 and the second lateral side 213.

According to this embodiment, there are a plurality of rolling units 22, each of the rolling units 22 is disposed in each of the recesses 215, each of the rolling units 22 has a fastening seat 222 detachably received in each of the recesses 215 and a plurality of rolling members 221 disposed on the fastening seat 222, and each of the rolling members 221 is a rolling wheel.

A plurality of medicines 100 are disposed in each of the storage boxes 23, then the storage boxes 23 are disposed on the inclined top wall 211 and the rolling unit 22 and adjacently arranged between the first lateral side 212 and the second lateral side 213, a font side of each of the storage boxes 23 has an opening 231 and two lateral blocking plates 232 disposed at two sides and upwardly extended, and each of the two lateral blocking plates 232 are correspondingly arranged with the two stopping plates 216.

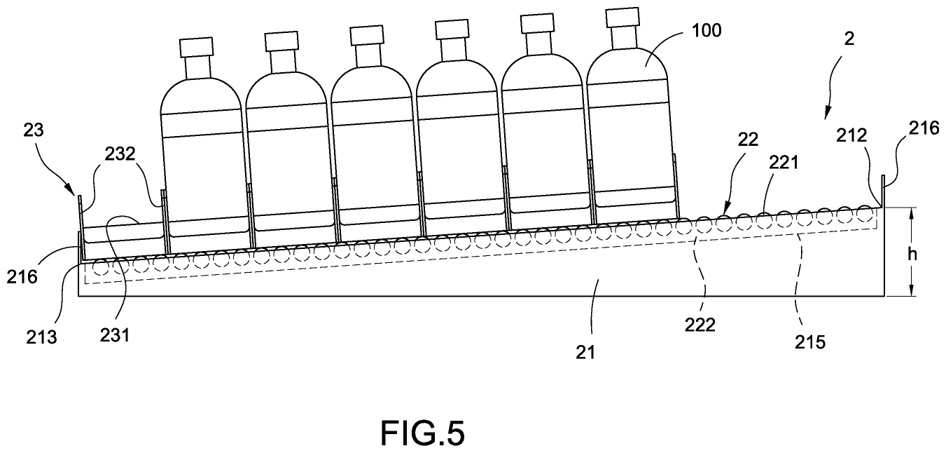

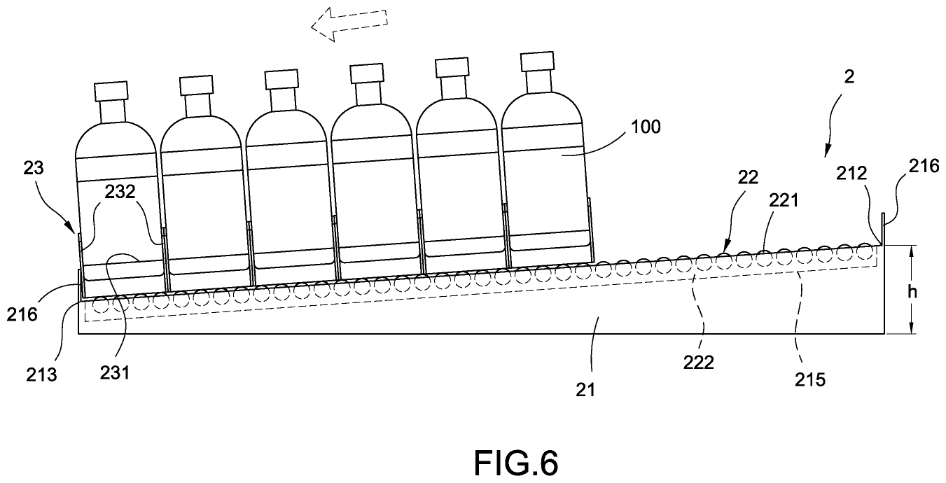

As shown in FIG. 1, FIG. 5 and FIG. 6, which disclose the operating statuses of the storage rack structure 10 and the storage panel module 2 according to the present invention; the storage boxes 23 are disposed on the inclined top wall 211 and the rolling unit 22 and adjacently arranged between the first lateral side 212 and the second lateral side 213, because the height h of the inclined top wall 211 is gradually reduced from the first lateral side 212 to the second lateral side 213, when the storage box 23 adjacent to the second lateral side 23 is taken out, the other storage boxes 23 on the inclined top wall 211 are able to automatically slide from the first lateral side 212 towards the second lateral side 213 through the rolling unit 22.

Accordingly, when an expire date managing operation for the medicines 100 is desired to be processed, the expire date which is about to reach is disposed more closer to the second lateral side 213, and the medicines 100 stored in the storage box 23 adjacent to the second lateral side 213 are firstly taken out, so that, with the storage boxes 23 and the rolling units 22, the expire dates, from the newest to the oldest, of the medicines 100 can be automatically managed and arranged from the first lateral side 212 to the second lateral side 213 of the inclined top wall 211, thereby allowing the storage rack structure 100 and the storage panel module 2 thereof to be provided with advantages of easily taking out the medicines 100 and efficiently managing the expire dates of the medicines 10.

The two stopping plates 216 are upwardly extended from the first lateral side 212 and the second lateral side 213 of the inclined carrying panel 21, so that the storage box 23 is prevented from falling out from the inclined carrying panel 21 while sliding; the front end of each of the storage boxes 23 has the opening 231 and the two lateral blocking plates 232 upwardly extended at the two sides, so that the medicines 100 can be easily taken out and the medicines 100 can also be prevented from falling out from the storage box 23 while sliding, thereby further increasing the operation conveniences of the storage rack structure 10 and the storage panel module 2 thereof.

Moreover, each of the rolling units 22 has the fastening seat 222 detachably received in each of the recesses 215 and the plurality of rolling members 221 disposed on the fastening seat 222, so that when the rolling unit 22 is damaged due to being worn by friction while rolling in a long period of time or adhered with dirt and unable to roll, the old rolling unit 22 can be directly removed from the recess 215, and the new rolling unit 22 is disposed in the recess 215 for a purpose of replacement, and a conventional means of replacing the whole inclined carrying panel 21 is not required, thereby allowing the storage panel module 2 to be provided with effects of easily replacing the rolling unit 22 and saving a maintenance cost.

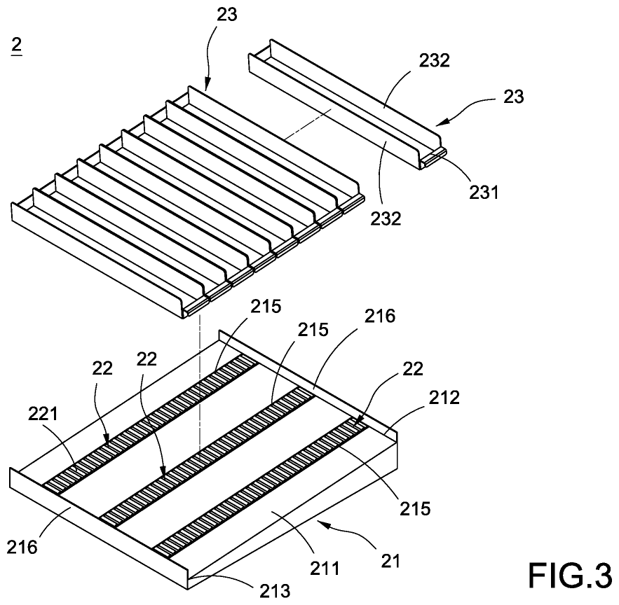

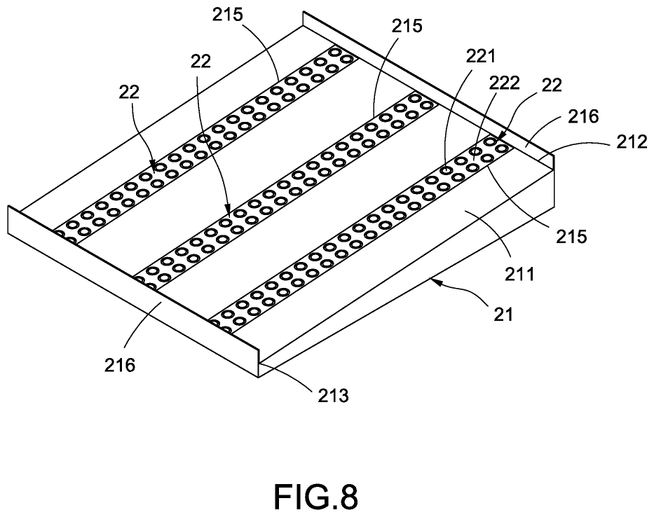

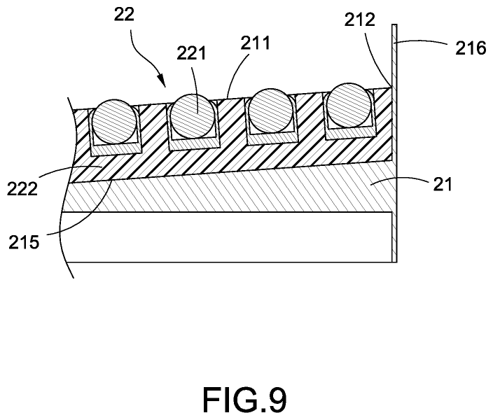

Please refer to FIG. 8 and FIG. 9, which discloses the inclined carrying panel 21 according to another embodiment of the present invention; the another embodiment disclosed in FIG. 8 and FIG. 9 is substantially the same as the embodiment disclosed from FIG. 3 to FIG. 7, a difference between the another embodiment disclosed in FIG. 8 and FIG. 9 and the embodiment disclosed from FIG. 3 to FIG. 7 is the structure of the rolling unit 22.

Details are provided as follows. Each of the rolling units 22 has the fastening seat 222 detachably received in each of the recesses 215 and the plurality of rolling members 221 disposed on the fastening seat 222, and each of the rolling members 221 is a rolling ball. Accordingly, the storage boxes 23 are able to automatically slide from the first lateral side 212 towards the second lateral side 213 through the rolling units 22, and the same functions and effects achieved in the embodiment disclosed from FIG. 3 to FIG. 7 can also be provided.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A storage rack structure, including:
a rack body, having at least one layer plate; and
a plurality of storage panel modules, disposed on the layer plate, wherein each of the storage panel modules includes:
an inclined carrying panel, having an inclined top wall and a first lateral side and a second lateral side arranged at two sides of the inclined top wall, and a height of the inclined top wall is gradually reduced from the first lateral side to the second lateral side;
at least one rolling unit, disposed on the inclined top wall and crossly arranged between the first lateral side and the second lateral side; and
a plurality of storage boxes, disposed on the inclined top wall and the rolling unit and adjacently arranged between the first lateral side and the second lateral side.

2. The storage rack structure according to claim 1, wherein there are a plurality of rolling units, the inclined top wall has a plurality of recesses crossly arranged between the first lateral side and the second lateral side, and each of the rolling units is received in each of the recesses.

3. The storage rack structure according to claim 2, wherein each of the rolling units has a fastening seat detachably received in each of the recesses and a plurality of rolling members disposed on the fastening seat, and each of the rolling members is a rolling wheel or a rolling ball.

4. The storage rack structure according to claim 1, wherein the inclined carrying panel has two stopping plates upwardly extended from the first lateral side and the second lateral side.

5. The storage rack structure according to claim 4, wherein a font side of each of the storage boxes has an opening and two sides thereof have two lateral blocking plates upwardly extended, and each of the two lateral blocking plates are correspondingly arranged with the two stopping plates.

6. A storage panel module, including:
an inclined carrying panel, having an inclined top wall and a first lateral side and a second lateral side arranged at two sides of the inclined top wall, wherein a height of the inclined top wall is gradually reduced from the first lateral side to the second lateral side;
at least one rolling unit, disposed on the inclined top wall and crossly arranged between the first lateral side and the second lateral side; and
a plurality of storage boxes, disposed on the inclined top wall and the rolling unit and adjacently arranged between the first lateral side and the second lateral side.

7. The storage panel module according to claim 6, wherein there are a plurality of rolling units, the inclined top wall has a plurality of recesses crossly arranged between the first lateral side and the second lateral side, and each of the rolling units is received in each of the recesses.

8. The storage panel module according to claim 7, wherein each of the rolling units has a fastening seat detachably received in each of the recesses and a plurality of rolling members disposed on the fastening seat, and each of the rolling members is a rolling wheel or a rolling ball.

9. The storage panel module according to claim 6, wherein the inclined carrying panel has two stopping plates upwardly extended from the first lateral side and the second lateral side.

10. The storage panel module according to claim 9, wherein a font side of each of the storage boxes has an opening and two sides thereof have two lateral blocking plates upwardly extended, and each of the two lateral blocking plates are correspondingly arranged with the two stopping plates.
